(19) United States
(12) Patent Application Publication
(10) Pub. No.: US 2005/0154897 A1
(43) Pub. Date: Jul. 14, 2005

(54) Protected access to a secured entity through a randomly selected password requested through an interactive computer controlled display terminal

(75) Inventors: Lane Thomas Holloway, Pflugerville, TX (US); Walid M. Kobrosly, Round Rock, TX (US); Nadeem Malik, Austin, TX (US); Avijit Saha, Somers, NY (US)

Correspondence Address: Mark E. McBurney;International Business Machines Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 10/755,903

(22) Filed: Jan. 13, 2004

(51) Int. Cl. H04K 1/00

(52) U.S. Cl. 713/183

(57) ABSTRACT

Instead of alphanumeric passwords, the entry of answers to questions that have obscure answers known only to the user is solicited. However, it is recognized that even items of obscure information could be found out by identity thieves. Therefore, many of such questions are set up, and then one or more of such questions are randomly selected to prompt the user seeking entry. This should thwart the hacker who might have come upon any one of such items of obscure information. The stored user database of questions and answers for protecting access to a secured entity may be carried on a card, such as a smart card. This portable card would include means for storing data representative of a plurality of questions requiring obscure answers known only to the user of the card. The data processor controlled display terminal protecting entry to the secured database or facility would include apparatus enabling the selective operative coupling of said portable card with said display terminal in combination with apparatus responsive to said coupling of said card to said display terminal for prompting said user on the display terminal to answer at least one of said stored questions selected at random.

### TECHNICAL FIELD

The present invention relates to user interactive computer supported display technology and particularly to the protection of secured access to computers, computer databases and other facilities and entities protected through password entry via user interactive computer controlled displays.

### BACKGROUND OF RELATED ART

In recent years, convergence of the data processing industry with the consumer electronics and communications industries has accelerated extensive consumer and business involvement in computer driven technologies. As a result of these changes, all aspects of work in business and technology requires human/computer interfaces. There is a need to make computer directed activities accessible to a substantial portion of people who, up to a few years ago, were computer illiterate or, at best, computer indifferent. In order for the extensive computer supported market places to continue and be commercially productive, it will be necessary for a large segment of computer indifferent workers and consumers to be involved in computer interfaces. Thus, the challenge of technology is to create display interfaces to such computers that are as close as possible to the real world of the user.

One of the great challenges of protected computers and networks of computers is to permit users to use passwords that are intuitive and relatively easy to remember, but are still hard to steal or hack. Because passwords are required at many levels in a variety of systems, the user is presented with a dilemma. If he tries to remember all of his passwords, he is more likely to forget one. If he writes the passwords down somewhere, then he defeats the whole purpose of passwords, i.e. secrecy. The user could compromise by creating an all purpose single password to be used whenever it satisfies a formula permissible by a security system. Of course, that would make all of the user's protected systems much easier to hack, i.e. the hacking of a single password could give access to all protected systems. In addition, there are a rising number of universal computer controlled display terminals available for a wide variety of financial, marketing, voting and information purposes that can be activated from a variety of points outside of the user's home or office computer that may be accessed through inputting the user's password or I.D. into interactive displays, e.g. activatable display terminals: electronic kiosks marketing a variety of goods or dispensing information as in airports or railroad stations. Display terminals are increasingly being used for public and business purposes.

While such universal display terminals may be controlled through external buttons or pointing devices, the prevalent number of such terminals are touch screen terminals. Such terminals are easy to use because they allow the user to point directly to the display screen with his finger, a pen or a stylus to make selections. The touch panel has been in use in various forms for several years. Several different technologies have been involved in touch panels. Original touch panels used a series of infrared LEDs and light sensors, such as photodiodes, to provide low resolution panels of up to 50 resolvable positions. The LEDs and sensors form a grid of invisible light beams that the finger breaks, thus, indicating its position. The capacitively coupled touch panels were able to develop a resolution of about 100 resolvable positions. Higher resolution touch screens have been developed using a variety of technologies from sound waves reflected off fingers to conductive/resistive layers separated by insulative material broken down by touch.

Virtually all computer display systems require security in the form of at least one password in order to enter and/or access the contents therein. Even where the contents are not computers and computer controlled data, passwords are often required, e.g. just to enter a secured room. Thus, the demand for passwords enters into all aspects of computer controlled systems. There is a need for a password system that is intuitive, easy to remember and unhackable.

### SUMMARY OF THE PRESENT INVENTION

The present invention provides a solution that satisfies all of the above-mentioned shortcomings of passwords. Instead of alphanumeric passwords, the invention solicits the entry of answers to questions that have only obscure answers and are known only to the user. However, the invention recognizes that even items of obscure information could be found out by identity thieves. The invention sets up many such questions and then randomly selects one or more of such questions to prompt the user seeking entry. This should thwart the hacker who might have come upon any one of such items of obscure information.

Accordingly, in its broadest aspects, the present invention involves the combination of means for prompting a user to enter a plurality of specific answers to questions soliciting obscure answers readily known only to said user during the setting up of the question and answer pool, together with means for storing said questions and said answers. Then when the user is seeking access, the invention provides means for enabling the user to access said computer system including means for prompting the user to answer at least one of the questions selected at random and means for permitting said user to access the system if said answer is correct.

During the set up of the questions, the system prompts the user via the computer display terminal to enter data in response to questions that are known to the user to solicit obscure data, e.g. mother's maiden name, father's birthday; but the invention also provides for the user setting up questions for data peculiar to the user himself, e.g. first dog's name.

The invention further provides for the situation wherein an identity thief may have obtained a cache of data particular to the user. The invention provides for precluding a question answer not entered within a set period of time. Under such circumstances, where the user may be slow in responding, the system may be set up to further prompt the user to answer a sequence of questions selected at random.

The question and answer data initially set up by the user may be stored at the computer or other facility to which user access is sought. This would conveniently be the case where the access is sought to the user's own computer or a local network including the user in connection with a client computer. Then the questions and answers could be stored at the computer or in a database served by a server supporting the local computer. However, in a more universal or global universal computer controlled display terminal as described above available for a wide variety of financial, marketing, voting and information purposes that can be activated by a variety of points outside of the user's home computer that may be accessed through inputting the user's password or I.D. into interactive displays, e.g. activatable display terminals: electronic kiosks. The present invention comprehends a password system for protecting access to a secured entity that would include a card, such as a smart card carrying the stored question and answer data. This portable card would include means for storing data representative of a plurality of questions requiring obscure answers known only to the user of the card. The data processor controlled display terminal would include means enabling the selective operative coupling of said portable card with said display terminal in combination with means responsive to said coupling of said card to said display terminal for prompting said user on the display terminal to answer at least one of said stored questions selected at random. There are means for permitting said user to access said secured entity if said answer were correct.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit, a primary display and data entry means that is capable of implementing the present invention at a user's computer;

FIG. 2 is a block diagram of a data processing system including a central processing unit, a primary display with a touch screen and means for receiving a card with user stored question/answer data that is capable of implementing the present invention at universal access display terminals;

FIG. 3 is a diagrammatic view of a display screen set up for prompting the user to enter the questions and obscure answers that will be stored and subsequently used for password purposes;

FIG. 4 is a diagrammatic view of a display screen, like that of FIG. 3, but set up for prompting the user to enter their own personalized questions and obscure answers that will also be stored and subsequently used for password purposes;

FIG. 5 is a flowchart of how the programs and routines implementing the present invention may be set up to solicit and store questions having obscure answers and to subsequently randomly present such questions to users seeking password entry;

FIG. 6 is a flowchart of a process carrying out the data entry aspect of the set up of FIG. 5; and

FIG. 7 is a flowchart of a process carrying out the aspect of the process set up in FIG. 5 to randomly present the password questions to the user seeking entry.

### DETAILED DESCRIPTION OF THE PREFERRED EMBODIMENT

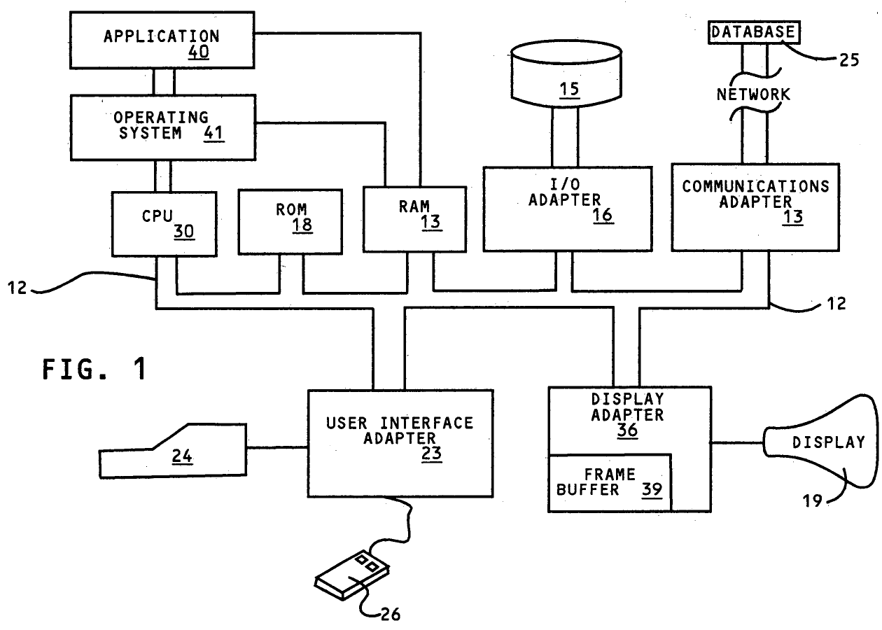

Referring to FIG. 1, a data processing system is shown that may function as the computer controlled display terminal on which the user who is setting up his randomly selected password system may be prompted to provide questions that will solicit answers of obscure information known only to the user. The display terminal, or one having its basic elements may, of course, also be used, as the facility or database protective terminal that the user may be prompted for passwords through the random selection of the stored questions requiring the obscure answers. A central processing unit (CPU) 30, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX operating system available from IBM; Microsoft's WindowsMe™ or Windows 2000™, as well as various other UNIX and Linux operating systems. Application programs 40, controlled by the system, are moved into and out of the main memory Random Access Memory (RAM) 13. These programs include the programs of the present invention for prompting the user to provide questions that will solicit answers of obscure information known only to the user and subsequently for passwords through the random selection of the stored questions requiring the obscure answers. A Read Only Memory (ROM) 18 is connected to CPU 10 via bus 12 and includes the Basic Input/Output System (BIOS) that controls the basic computer functions. RAM 13, I/O adapter 16 and communications adapter 13 are also interconnected to system bus 12. I/O adapter 16 may be a Small Computer System Interface (SCSI) adapter that communicates with the disk storage device 15. Communications adapter 13 interconnects bus 12 with an outside network enabling the data processing system to communicate with other such systems over a Local Area Network (LAN) or a Wide Area Network (WAN) that includes, of course, the Web or Internet, reach databases 25 containing information pertinent to the user. I/O devices ate also connected to system bus 12 via user interface adapter 23 and display adapter 36. Keyboard 24 and mouse 26 are all interconnected to bus 12 through user interface adapter 22. It is through such input devices that the user may interactively relate to Web pages that prompt the user. Display adapter 36 includes a frame buffer 39 that is a storage device that holds a representation of each pixel on the display screen 19. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 19.

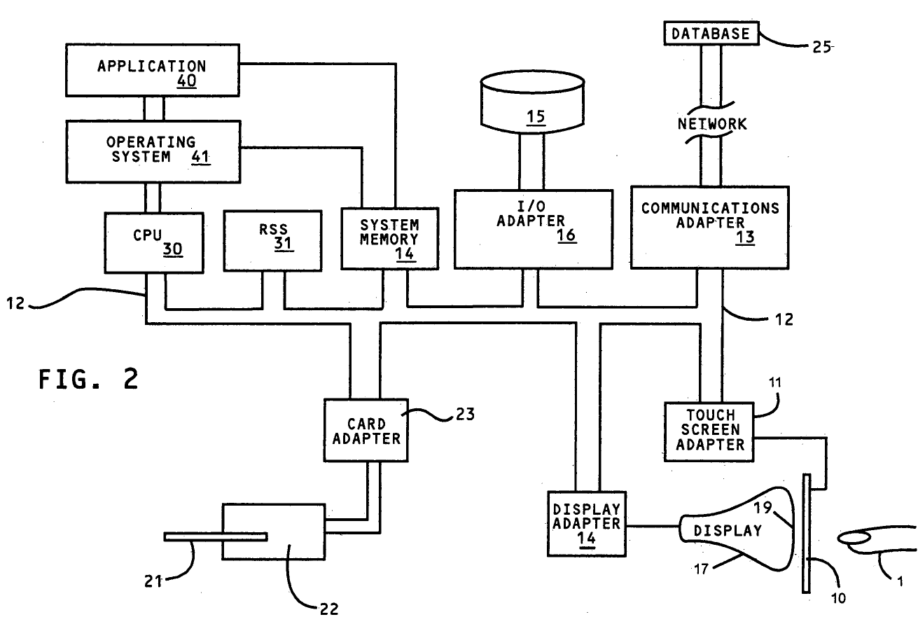

The present invention may advantageously be used for the entry of passwords at universal or global computer controlled display terminals, such as kiosks that protect access to commercial and e-business databases among others, as will be described with respect to FIG. 2. In describing FIG. 2, it will be assumed that the user has already been prompted for the sequence of questions and their obscure answers on another display terminal, e.g. their own personal computer and that the question and answers have been stored, e.g. on a portable smart card. A conventional central processing unit (CPU) 30, such as described above with respect to FIG. 1, is provided and interconnected to various other components by system bus 12. An operating system 41 runs on CPU 30 and provides control and is used to coordinate the functions of the various components of FIG. 1. Operating system 41 may be one of the commercially available operating systems, such as the operating systems described above with respect to FIG. 1. The system, of course, may be modified to eliminate elements not needed by the universal terminals such as vending kiosks. A programming application for operating the present invention, application 40, as described above, runs in conjunction with operating system 41 and provides output calls to the operating system 41 that implement the various functions to be performed by the application 40. A Read Only Storage (ROS) memory 31 is connected to CPU 30 via bus 12 and includes the BIOS that controls the basic computer functions. RAM system 32, I/O adapter 16 and communications adapter 13 are also interconnected to system bus 12. It should be noted that software components, including the operating system 41 and the application 40, are loaded into memory system 32, which is the computer system's main memory. I/O adapter 16 conventionally communicates with the disk storage device 15, i.e. a hard drive. Communications adapter 13 interconnects bus 12 with outside networks, such as the Internet, to enable the data processing system to communicate with other such systems, particularly database 25 from which data specific to the user of the inserted card may be obtained. The withdrawable user card 21 is inserted into card reader 22 that is connected via card adapter 23 and bus 12. The user data from the card is stored in the system memory along with any data specific to the user that is obtained from database 25. Any conventional touch screen display may be used. Typically, FIG. 1, there is a display 17 having surface 19 upon which the visual output from the computer is generated via display adapter 14. A touch sensitive display screen or panel 10 is superimposed upon display surface 19. This touch screen, which is about ¼″ to ½″ from surface 19, is responsive to a touch stimulus, e.g. finger 18, applied by the user to issue commands to the computer system. The touch screen 10 resolution is determined by digitizing circuitry (not shown) in a pointing device adapter 11 to form a two-dimensional array of discrete coordinate points. A touch stimulus applied to any of the coordinate points is detected by a sensor array (not shown) in the touch screen 10. The sensor array generates an analog signal responsive to the force imparted to the touch screen. This signal is digitized by a sampling A to D convertor circuit (not shown) in touch screen 10 to produce an input data value. This data value, together with the coordinates to which it relates, are transmitted from touch screen 10 to touch screen adapter 11. The input data value corresponding to each set of coordinates is conventionally refreshed by the A to D converter circuit about 60 times a second. The pointing device adapter 11 connected to the bus architecture 12 passes each set of coordinates and the corresponding input data value to the bus architecture 12.

The touch panels or screens 10 may use any of the standard technologies. One current conventional technology uses higher resolution panels with resistive/conductive composites. Such structures use two slightly separated layers of transparent material, one coated with a thin layer of conductive material and the other with resistive material. The pressure of the fingertip forces the layers to touch and the voltage drop across the resistive substrate is measured and used to determine the coordinates of the touched positions. There are many such conductive/resistive touch screen displays on the market that may be used in the implementation of the present invention, such as the IBM 2489 Model 600 and PGI Super Nightingale. The set of user specific questions and their answers relating to obscure information known only to the user may be stored on smart card 21 and read into the system memory 32 from which the programs to be subsequently described in detail may randomly generate the questions to solicit the obscure information password answers needed to give the user access to the system.

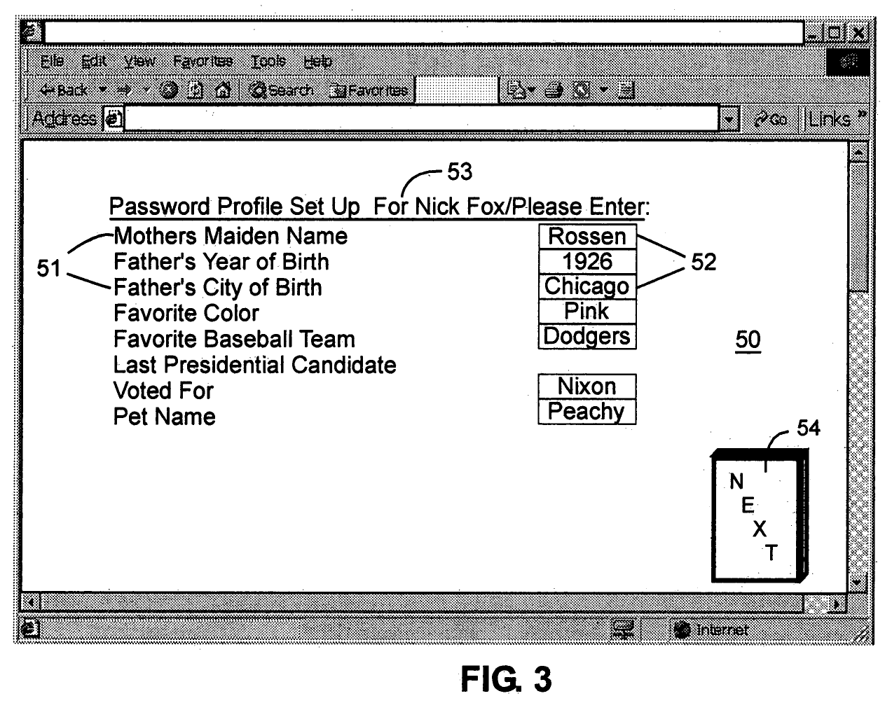

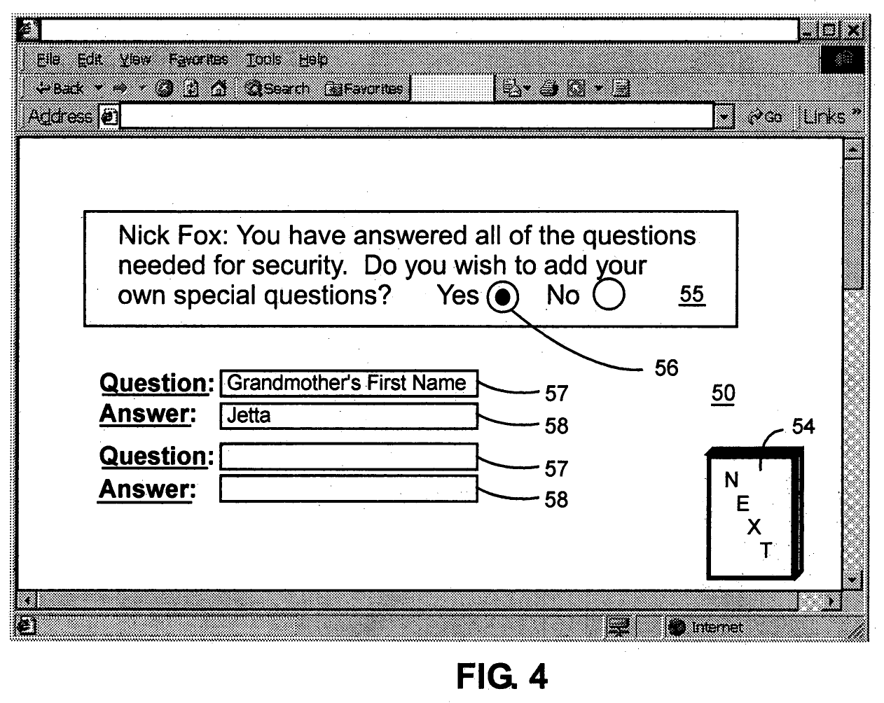

Now, with respect to FIGS. 3 and 4, there will be provided an illustrative example of how the present invention may be used to prompt a user at a computer controlled display station for data entries to help define a universal password system for the user. The objective is to create a database of questions having answers that are sufficiently obscure so that they would be intuitively known to the particular user but not available in any source of information available to the public. The data may be entered on a display terminal like that of FIG. 1, and, conveniently, the user's own personal computer. Actually, the data could also be entered into a kiosk-like terminal shown in FIG. 2, but the entry would be slower and less convenient as there would be no keyboard. Thus, on the display computer of FIG. 1, the user is prompted with the display screen 50 of FIG. 3, e.g. the “Password Profile Setup for Nick Fox” 53, wherein the user is prompted with a set of standard questions 51 soliciting answers 52 that would be presumed to be remote and obscure and known only to the user, Nick Fox. Virtually dozens of such questions could be prompted and the user could select and answer only those that were intuitively known to him. After the user has selected the answers, he may proceed to the next screen by clicking on the next button with the mouse pointer. Here, to complete the obscure question/answer profile, the user is also prompted, FIG. 4, to create as many such questions/answers as he wishes to add to the profile. Prompt box 55 asks the user whether he wishes to create such questions/answers and the user has selected “YES” 56. Thus, the user proceeds to enter such questions 57 and answers 58. Here again, the user may create dozens of such questions/answers. The computer on which the question/answer data is entered processes this data and creates the personalized database for this user. In simple set ups, this personalized database may be stored locally in association with the user's computer. In fixed and established networks that the user accesses through client computers, this information, this user personalized database may be stored in association with an appropriate network server. However, when the database is to be used for access to universal networks, e.g. entry via kiosks as shown in FIG. 2, then the portable database, e.g. on a smart card, is most appropriate.

In using such a kiosk touch screen for password entry, display screen images are presented to the viewer on screen 19 of display monitor 17 of FIG. 2. In accordance with the standard touch screen techniques described above, the user may control the screen interactively through finger 18 touching touch screen 10 that operates through pointing device adapter 11 and bus 12 to call upon the routines in application program 40 that is loaded in system RAM 32 cooperating with the operating system 41 to create the images display adapter 14 to control the display screen 19 on display monitor 38.

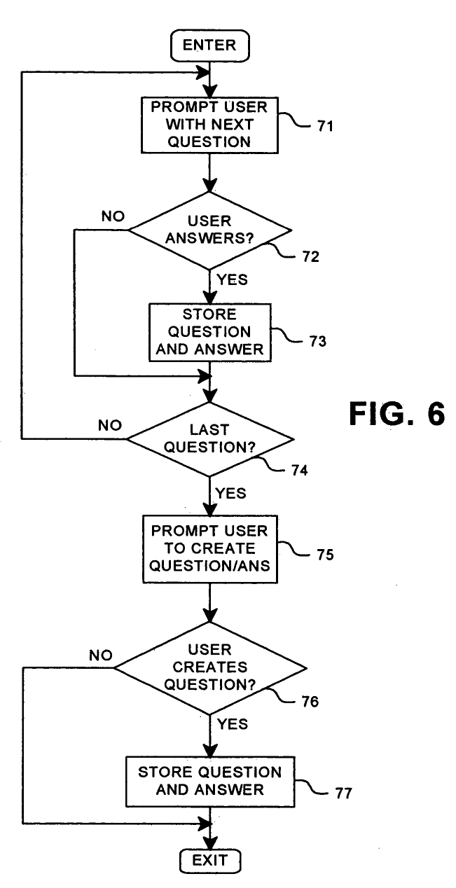

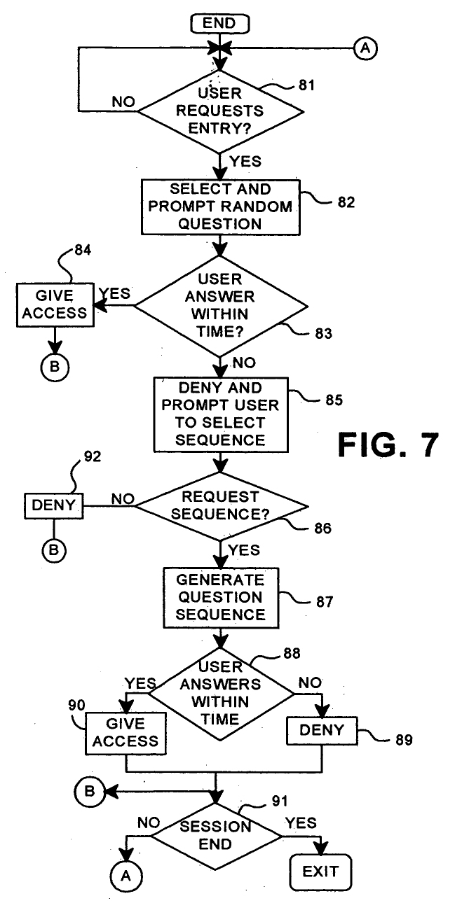

The withdrawable cards 21 used in the present invention may have any conventional structure used in personalized cards for universal computer controlled display terminals. The card may also be a smart card, i.e. it contains integrated circuitry with a limited amount of intelligence through logic. The smart card, and related smart media, is described in detail at pp. 388-389 of the text, Winn L Rosch Hardware Bible, 5th Edition, 1999, Que Division of MacMillan Publishing, Indianapolis, Ind. The stored database of questions having obscure answers known only to the user may be stored in the conventional manner on such smart cards so that the questions and respective answers may be randomly selected, as will hereinafter be described with respect to FIGS. 6 and 7.

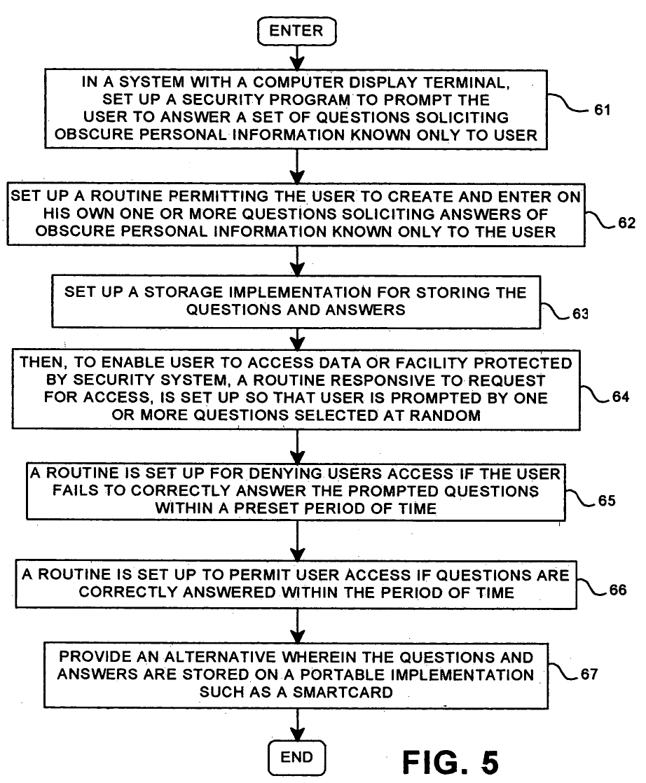

In the meantime, the setting up of the programming elements of the invention will be described with respect to FIG. 5. On a display panel of an interactive computer interface, a program is set up to prompt the user to answer a set of questions soliciting obscure personal information known only to the user, step 61. A complementary routine is set up to prompt the user to interactively create and enter a set of his own questions soliciting answers of more obscure information known only to the user, step 62. An implementation for storing all of the obscure answers and questions is set up, step 63.

At this point in order to enable user to access data or a facility protected by a security system, a routine responsive to a request for access is set up so that the user is prompted by one or more questions selected at random, step 64. A complementary routine is set up for denying user access if the user fails to correctly answer the prompted questions within a preset period of time, step 65. A further routine is set up for permitting user access if the questions are correctly answered within the period of time, step 66. Finally, provision is made for an implementation, such as a smart card, wherein all of the questions and obscure answers are stored in local databases on a smart card, step 67.

The running of the process set up in FIG. 5 and described in connection with FIGS. 3 and 4 will now be described with respect to the flowcharts of FIGS. 6 and 7. Let us assume that the user is setting up his randomly selected question/answer password system. The flowchart in FIG. 6 represents some steps in a routine that will illustrate the operation of the invention. The user is first or next prompted on the data entry display computer to determine whether he wishes to use the next of an offered sequence of questions determined to usually have obscure answers known only to the user, step 71. If Yes, step 72, that selected question and the user's answer are stored, step 73. Then, or if the answer in step 72 is No, a determination is conveniently made as to whether the question is the last of the standard questions to be offered to the user, step 74. If No, then the process flow is returned to step 71, and the next question is prompted to the user. If the determination in step 74 is Yes, then the user is prompted to create one or more questions personal to him that will solicit obscure answers known only to him, step 75. Then, a determination is made as to whether the user has chosen to create one or more questions, step 76. If Yes, those user created questions and answers are stored, step 77. Then, or if the determination in step 76 is No, the session for setting up the database of questions with obscure answers for random password requesting is completed, and the session is exited.

Now, with respect to FIG. 7, assume that the database of questions/obscure answers has been set up and stored on a smart card and a user wishes to access a database through a universal kiosk, such as that described with respect to FIG. 2. An initial determination is made as to whether the user requests entry, step 81. If Yes, then, the routine selects one of the questions from the database at random and prompts the user for the obscure answer, step 82. A determination is then made as to whether the user has answered within a preset reasonable time, step 83. If Yes, the user is given access, step 84. If No, i.e. the user has the answer wrong or the answer time has run out, the system may still be set up to distinguish an improper request for access from one where the user has made an honest mistake. Access is denied, step 85, but the user may optionally now be prompted with a randomly selected sequence of questions requiring obscure answers. For example, upon denying access, the display may offer the user the following:
“YOUR PASSWORD ANSWER IS INCORRECT. IF YOU BELIEVE THIS TO BE IN ERROR, PLEASE PRESS YES AND YOU WILL BE PROMPTED WITH A SEQUENCE OF QUESTIONS THAT YOU MUST ANSWER WITHOUT DELAY”
   If the user then selects the sequence, Yes, decision step 86, the sequence of random questions is generated, step 87. If No, access is denied, step 92. If the sequence is generated, a determination is made, step 88, as to whether the user has correctly answered the questions in the sequence within the preset times. If Yes, access is given, step 90. If No, access is denied, step 89. Next, a determination is conveniently made, step 91, as to whether the access session is over. This determination should also be made after the denials in steps 84 and 92 as indicated by branch “B”. If Yes, the session is exited. If No, the session is returned to initial step 81 via branch “A”.

Although certain preferred embodiments have been shown and described, it will be understood that many changes and modifications may be made therein without departing from the scope and intent of the appended claims.

1. In a user interactive display computer system, a password system protecting access to said computer system comprising:
means for prompting a user to enter a plurality of specific answers to questions soliciting obscure answers readily known only to said user;
means for storing said questions and said answers; and
means for enabling said user to access said computer system including:
means for prompting the user to answer at least one of said questions selected at random; and
means for permitting said user to access system if said answer is correct.

2. The display computer system of claim 1 wherein said means for enabling user access further includes means for precluding a question answer not entered within a set period of time.

3. The display computer system of claim 1 wherein said means for prompting prompts the user to answer a sequence of questions selected at random.

4. The display computer system of claim 2 wherein in response to said means precluding a question answer, said means for prompting prompts the user to answer a sequence of questions selected at random.

5. The display computer system of claim 1 further including means for prompting said user to create and enter additional questions requiring obscure answers, said questions and answers being stored in said means for storing.

6. The display computer system of claim 1 further including:
a portable card carrying said means for storing; and
means in said computer system enabling the selective operative coupling of said portable card with said computer system.

7. In a user interactive display computer system, a password method for protecting access to said computer system comprising:
prompting a user to enter a plurality of specific answers to questions soliciting obscure answers readily known only to said user;
storing said questions and said answers; and
enabling said user to access said computer system including the steps of:
prompting the user to answer at least one of said questions selected at random; and
permitting said user to access the system if said answer is correct.

8. The method of claim 7 wherein said step of enabling user access further includes the step of precluding a question answer not entered within a set period of time.

9. The method of claim 7 wherein said user is prompted to answer a sequence of questions selected at random.

10. The method of claim 8 wherein in response to said step of precluding a question answer, said user is prompted to answer a sequence of questions selected at random.

11. The method of claim 7 further including the step of prompting said user to create and enter additional questions requiring obscure answers, said questions and answers being stored together with said original questions requiring obscure answers.

12. A computer program having program code included on a computer readable medium for protecting access to a user interactive computer display system comprising:
means for prompting a user to enter a plurality of specific answers to questions soliciting obscure answers readily known only to said user;
means for storing said questions and said answers; and
means for enabling said user to access said computer system including:
means for prompting the user to answer at least one of said questions selected at random; and
means for permitting said user to access system if said answer is correct.

13. The computer program of claim 12 wherein said means for enabling user access further includes means for precluding a question answer not entered within a set period of time.

14. The computer program of claim 12 wherein said means for prompting prompts the user to answer a sequence of questions selected at random.

15. The computer program of claim 13 wherein in response to said means precluding a question answer, said means for prompting prompts the user to answer a sequence of questions selected at random.

16. The computer program of claim 12 further including means for prompting said user to create and enter additional questions requiring obscure answers, said questions and answers being stored in said means for storing.

17. A password system for protecting access to a secured entity comprising:
a portable card including means for storing data representative of a plurality of questions requiring obscure answers known only to the user of the card;
a data processor controlled display terminal including means enabling the selective operative coupling of said portable card with said display terminal;
means responsive to said coupling of said card to said display terminal for prompting said user on the display terminal to answer at least one of said stored questions selected at random; and
means for permitting said user to access said secured entity if said answer is correct.

18. The password system of claim 17 wherein said portable card is a smart card.

19. A password method for protecting access to a secured entity comprising:
prompting a user to enter, through an interactive computer controlled display terminal, a plurality of specific answers to questions soliciting obscure answers readily known only to said user;
storing said questions and said answers in association with said display terminal;
prompting said user on the display terminal to answer at least one of said stored questions selected at random; and
permitting said user to access said secured entity if said answer is correct.

20. A computer program having program code included on a computer readable medium for protecting access to a secured entity comprising:
means for prompting a user through an interactive display terminal to enter a plurality of specific answers to questions soliciting obscure answers readily known only to said user;
means for storing said questions and said answers in association with a display terminal protecting said access;
means for prompting said user on the display terminal to answer at least one of said stored questions selected at random; and
means for permitting said user to access said secured entity if said answer is correct.
